(19) United States
(12) Patent Application Publication
(10) Pub. No.: US 2015/0032874 A1
(43) Pub. Date: Jan. 29, 2015

(54) COMPUTER DATA VOLUME TRACKER SYSTEM AND METHOD

(71) Applicant: Wal-Mart Stores, Inc, Bentonville, AR (US)

(72) Inventors: Aaron R. Bartholomew, Noel, MO (US); William A. Hogg, Rogers, AR (US)

(73) Assignee: Wal-Mart Stores, Inc, Bentonville, AR (US)

(21) Appl. No.: 13/950,558

(22) Filed: Jul. 25, 2013

(51) Int. Cl. H04L 12/26

(52) U.S. Cl. CPC H04L 43/067
USPC 709/224

(57) ABSTRACT

A system and computer implemented method for use with an user device in communications with an enterprise system (ES) in a workplace, includes: tracking data volume and usage times, via a data volume tracker application, of one or more enterprise software applications in the user device; storing the data volume, duration of usage times and actual date and time of usage in a memory wherein the data volume tracker application differentiates the stored data transferred to and from each service provider, for each connection type and for each of the enterprise software applications; and periodically reporting the stored data to a central computer of the ES, wherein the data volume tracker application, the enterprise software applications and the memory are each resident on the user device.

### FIELD OF THE INVENTION

The present invention relates generally to a computer system and method for data volume tracking, and more specifically to tracking data volume and usage relating to communications of an user's mobile device on a per-application or per-service endpoint level in cooperation with an enterprise system in a workplace.

### BACKGROUND

An enterprise information system also known as an enterprise system (ES) is generally any kind of computing system that is of enterprise class. This means typically offering high quality of service, dealing with large volumes of data, and being capable of supporting a large organization, i.e. an enterprise. An enterprise system is a corporate computer network.

Enterprise information systems provide a technology platform that enables organizations to integrate and coordinate their business processes. An enterprise information system provides a single system that is central to the organization and that ensures that information can be shared across all functional levels and management hierarchies. Enterprise systems create a standard data structure and are invaluable in eliminating the problem of information fragmentation caused by multiple information systems within an organization. A typical enterprise information system would be housed in one or more data centers, would run enterprise software, and could include applications that typically cross organizational borders such as content management systems.

Mobile communications devices such as cell phones, smart phones, lap tops, computer tablets, etc. are changing the fundamental way that people communicate both at work and within their personal lives. In some cases a singular mobile device can be used, for work and for personal use. The terms “user”, “end user”, “consumer”, “employee” and “device owner” are all interchangeable terms referring to an individual user of a mobile communications device that is connected to an ES.

In the consumerization of information technology (IT), bring your own device (BYOD) is a phrase that has become widely adopted to refer to employees who bring their own computing devices such as smart phones, laptops and personal digital assistants (PDAs) to the workplace for use and connectivity on the ES or corporate network. To this end there will be computer applications, routines or processes (i.e. an enterprise application) provided by an enterprise system to enable a business associate to use his/her own mobile device. Since many data plans are limited according to a number of variables such as usage times and costs, the consumer/user will want the capability to view data usage when linked to an enterprise application. In the case where multiple enterprise applications are installed onto a user's mobile device the consumer may also want to see consolidated application usage as well as individual application usage. There is also a need for understanding data usage from an enterprise perspective, for multiple purposes including but not limited to, application data efficiencies, connection preferences & troubleshooting. The data provided by the consumer can be either identifiable or anonymous depending upon the specific enterprise system requirements and/or the consumer's preference.

### BRIEF SUMMARY OF EMBODIMENTS

When a mobile device owner uses a mobile application, that application connects to data providers commonly known as services via a network connection in order to retrieve data for use within the application. When the user connects to one of the services, a communications summary can be sent to an on-device data volume tracker whereby the summary can include information such as but not limited to: specific application data; identification of the network connection type; data volume sent; data volume received; identification of services called; and separate numbers of data volumes sent and received to and from each service. The aggregate of this summary, without the service call information, is available to the device owner.

On a regular configurable basis the on-device data volume tracker can send the data from each of the above communication summaries to an enterprise volume tracking service. By preference this information is sent when a wireless connection is available, but if a sufficient configurable and predetermined amount of time has passed since the last volume metrics were sent to the enterprise service, or if a sufficient number of summaries have accumulated, then any type of next available network connection can be used. User and device identifying information can also be included or restricted when transferring data depending upon company policy, government regulations, and user preferences.

Once the information from each device has been collected and stored, it can be queried and analyzed by a central server of the enterprise system. The business intelligence gained from this analysis can be used, for example, to tune applications or services that are consuming more data than designed.

A computer-implemented method includes the steps of: tracking data volume and usage times, via a data volume tracker application, of one or more enterprise software applications in the user device; storing the data volume, duration of usage times and actual date and time of usage in a memory wherein the data volume tracker application differentiates duration of usage time, actual date and time of usage, and volume of data transferred for each service provider, for each connection type and for each of the one or more enterprise software applications; and periodically reporting the stored data volume, duration of usage times and actual date and time of usage to a central computer of the ES, wherein the data volume tracker application, the one or more enterprise software applications and the memory are resident on the user device.

A system for tracking data usage includes one or more mobile user devices each including an enterprise device application for use within an enterprise system, a connection interface, a memory, an I/O device and a data volume tracker application for measuring tracking parameter data of the enterprise device application. A data volume aggregator is resident within a server of the enterprise system. The aggregator includes a volume tracking service for communicating with the one or more user devices, a storage device for storing parameter data received from the user devices, and an analysis engine for analyzing parameter data received from the user devices. A service call is initiated by user devices to contact a service via the connection interface to request or send information related to the enterprise device application, then the data volume tracker application measures and stores to the memory the parameter data from the user accumulated for a duration of the service call.

A computer program product for use in a mobile user device includes a computer readable storage medium having computer readable program code embodied therewith. The computer readable program code includes code configured: to track data volume transfers, usage times and bandwidth used by the user device for external communications via execution of an enterprise application loaded onto the user device; to store the data volume transfers, usage times and bandwidth in a memory within the user device and to differentiate data send times, data receive times, service provider data and connection type data; and to facilitate transfer of the stored data volume transfers, usage times and bandwidth to an enterprise system server.

The above and other aspects of various embodiments of the present invention will become apparent in view of the following description, claims and drawings.

### BRIEF DESCRIPTION OF THE SEVERAL VIEWS OF THE DRAWINGS

The accompanying drawings, in which like numerals indicate like structural elements and features in various figures, are not necessarily drawn to scale, the emphasis instead being placed upon illustrating the principles of the invention.

FIG. 1 is a block diagram representation of a first embodiment of a portion of an user's mobile device for use in communications with an enterprise system in accordance with the principles of the invention;

FIG. 2 is a block diagram representation of a second embodiment of a portion of an user's mobile device for use in communications with an enterprise system in accordance with the principles of the invention;

FIG. 3 is a block diagram representation of a third embodiment of a portion of an user's mobile device for use in communications with an enterprise system in accordance with the principles of the invention;

FIG. 4 is a block diagram of a data volume aggregator for use by an enterprise system in accordance with the principles of the invention;

FIG. 5 is a block diagram of service endpoints for use with the user mobile devices of FIGS. 1, 2 and 3;

FIG. 6 is a flow chart of steps of a method according to the principles of the invention; and

FIG. 7 is a block diagram of various steps performed when analyzing data in the method of FIG. 6.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

As will be appreciated by one skilled in the art, the present invention may be embodied as a method, system, or computer program product. Accordingly, the present invention may take the form of an entirely hardware embodiment, or an entirely software embodiment, including firmware, resident software, micro-code, etc., or an embodiment combining software and hardware aspects that may all generally be referred to herein as a “circuit”, “module” or “system”.

Furthermore, the invention may take the form of a computer program product accessible from a computer-usable or computer-readable medium providing program code for use by, or in connection with, a computer or any instruction system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tapes, a removable computer diskette, a portable computer diskette, a hard disk, a rigid magnetic disk, a magneto-optical disk, an optical storage medium, such as an optical disk including a compact disk read only memory (CD-ROM), a compact disk read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's mobile device, partly on the user's mobile device, as a stand-alone software package, partly on the user's device and partly on a remote computer, or entirely on the remote computer or server. In the latter scenario, the remote computer may be connected to the user's device through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, printing, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus devices and systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, mobile computing device, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer device or other programmable data processing apparatus to cause a series of operational steps to be performed on the computer device or other programmable apparatus to produce a computer implemented process such that the instructions which execute on the computer device or other programmable apparatus provide steps for implementing the functions/acts specified in the flowchart and/or block diagram block or blocks.

The computer data volume tracking system and method of the present invention can be either inserted into each Enterprise application, such as an application accessible by a BYOD device, or it can be present and used from an application container. An application container is a parent program which holds and executes a set of commands to run other software routines/programs.

The computer data volume tracking system and method can (1) monitor all network connections used by an application or application container; (2) cumulatively or separately track the volume of data sent by and received within the application or application container; (3) differentiate between various connection types such as cell, wired and wireless connections; and (4) separately keep track of the amount of information sent to and received by all cell connections, all wired connections and all wireless connections. Communications which do not use ES will not be monitored. If a capability as described above is part of an application container, the applications within the container can be differentiated so that the information sent from and received by each application within the container is accumulated, stored and maintained separately.

The amount of information sent from and received by each application or container can also be differentiated based upon the service endpoints used whereby the service endpoints each represent a particular service provided. For instance an internal service endpoint can be a local area network (LAN) or Ethernet service provided and maintained by a company or other private organization. Such an internal service would be managed by a business management rules engine according to the specific needs of the business or other organization. An external data endpoint service can be the Internet service, a third party service such as maps.google.com or another service owned by the enterprise. Other non-specified data endpoint services can also be provided.

Metrics can also be provided to determine and specify which particular user and user device consumes data and how much data is consumed. Most of this information is available to the end user on his/her mobile device, via a settings menu, data usage tracking option. Data available to the user can include the data quantity per network type (e.g. cellular, wired, wireless) as well as data quantity per application. Also the network type can be further defined by a specific carrier such as AT&T™, Verizon™, Sprint™ or T-Mobile™ wireless.

All of the data concerning each application located on an user's mobile device is periodically sent on a predefined frequency to a centralized service endpoint, such as to a central server located on the company's proprietary enterprise system. If the user's device was not used on a given day, and as a result the information could not be sent to the enterprise server as scheduled for that day, then the information could be sent at the next available usage downtime. The time for sending the information to the central server is based upon usage requirements and availability of connectivity. The data is preferably sent when neither the user's device nor the central server are not under significant usage.

Wireless connectivity is the preferred method of uploading data to the central server, unless an upload of data volume information had not occurred for some predetermined configurable time (such as a sample default value of 7 days), in which case the information would be sent via any next available connection.

A mobile device user, i.e. an end user, should be able to display application data resident on his/her device at any time. Also on a periodic basis such as one a month after all of the mobile device data has been transferred to the central server, the user should be able to clear the last month's stored information from his personal device. This feature allows the user to keep track of the company's data utilization in a sensible way without compromising the information used corporately.

Selected aspects of the invention include: (1) differentiating data volume levels according to connection type, application and service endpoint; (2) using connection awareness and usage awareness to determine when to send information from the user's mobile device to the central server; (3) user display of data volume metrics by application (across multiple application types) which allows the user to determine which applications to use on which networks, or at all; and (4) providing or obscuring device or user identifying metrics for security and privacy reasons. The ability to perform analysis that does not uniquely identify an user can be provided at the time of aggregating the metrics from the volume tracking service to data storage. This removal of uniquely identifying information can also be implemented at the time of analysis by obscuring the device or user identifying information retrieved from data storage. The personal data tracking and user identification features can be disabled when necessary.

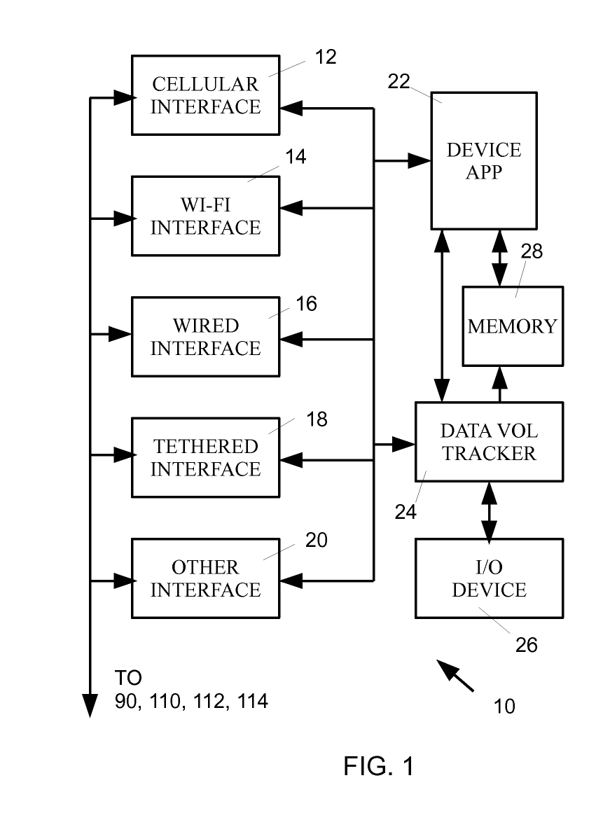

FIG. 1 is a block diagram representation of a first embodiment of a portion of an user's mobile device 10 for use in communications with an enterprise system including data volume tracking. In this embodiment no application container is present for containing the one or more applications 22 loaded onto the user device 10. The particular device 10 can include one or more of the various interfaces 12, 14, 16, 18 and 20 for connecting the device 10 to different services. A cellular interface 12 allows the device 10 to communicate with other devices remotely via a wireless cellular network or service. A wireless local area network (WLAN) or wi-fi interface 14 allows the device 10 to communicate with other devices remotely over a wireless local area network or service. A wired interface 16 allows the device 10 to communicate with other devices directly connected to a network or service. A tethered interface 18 allows the device 10 to communicate with other devices remotely over the Internet, and an other available interface 20 allows the device 10 to communicate with other devices via another network or service not identified above.

Tethering is the practice of using a mobile device such as a cell phone as a modem to connect another device such as a laptop to the Internet. A tether is a long leash and in phone tethering the leash is either a USB cable or a wireless Bluetooth connection. Universal serial bus (USB) is a well known connection technology for attaching peripheral devices to a computer, providing fast data exchange. Bluetooth™ is a short-range radio technology that allows wireless communication between a computer and a keyboard, between mobile phones, etc.

The device 10 also contains an I/O device such as a display or monitor 26, memory storage 28 and a data volume tracker program/application 24 which provides a computer program for tracking and gathering data for one or more of the on-board device applications 22. The applications 22 are pushed, loaded or otherwise installed onto the user device 10. Any communications with other devices on the enterprise network, the Internet or elsewhere are enabled via the various communications interfaces 12, 14, 16, 18 and 20.

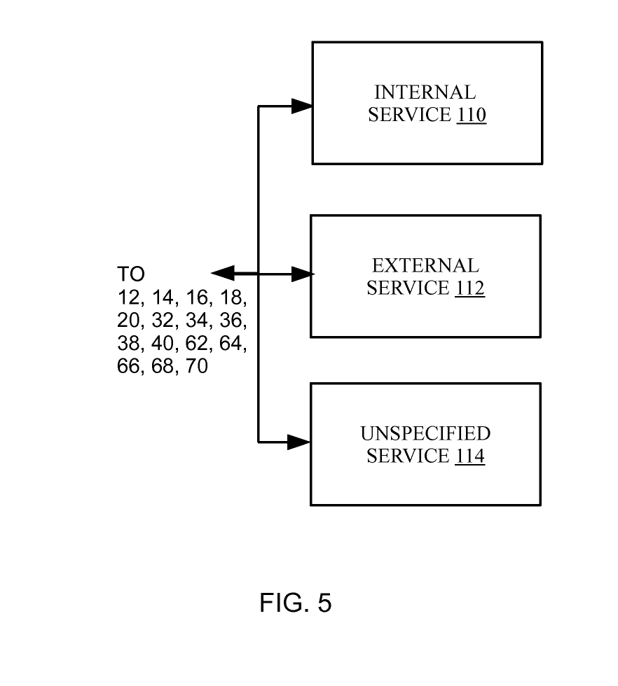

FIG. 5 is a block diagram of service endpoints for communication and use with the device application 22 of the user mobile device 10. Internal service endpoint 110 represents a company sponsored service internally available to employees. External service 112 represents a service available outside of the company, such as an Internet available service or a third party service. The data endpoint 114 represents any other service that may be available and not fall within the above described categories.

One device application 22, for example, may be useful for tracking data usage of individual employee devices such as a personal BYOD device 10 for doing store inventory. The application 22 will make calls to various services for accessing data relating to the store inventory. In this example, the store inventory information may be stored on a server of a corporate enterprise system or perhaps on a third party server available via the Internet.

When a service call is made from the application 22 to one of the services 110, 112, 114 (see FIG. 5), a data volume tracker application 24 will keep track of how much data is sent to and received by the personal device 10. The tracker application 24 tracks data usage, bandwidth and other data at either a per application level or at a per service endpoint level. The tracker application 24 can use any number of parameters for tracking data. Tracking parameters can include, but are not limited to: consumer bandwidth; identification of connection type; data plan identification; time, date and length of communications; differentiation of statistics for data received versus data sent; and device use time for a specific data plan.

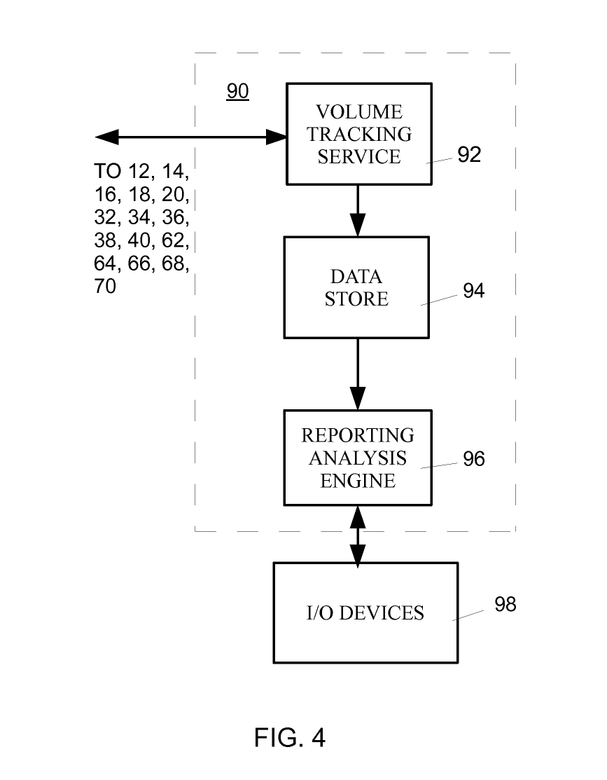

The usage data in the various forms mentioned above is periodically transferred from the mobile user device 10 to a data volume aggregator 90 (FIG. 4) where data collection, comparison and analysis occurs. The aggregator 90 is typically resident on a central server of the corporate enterprise system (or on a third party server). The transfer of data can be programmed to occur on a periodic basis, such as once per day, once per week, etc., or the data can be transferred when a certain threshold is met (e.g. when data stored on device 10 reaches a configurable size e.g. 4 MB, or allocated storage in memory 28 in the user device 10 reaches a configurable percentage of utilization e.g. 90% full), or the data can be transferred manually by the user or upon request by the central server 90.

The data volume aggregator 90 of FIG. 4 includes: a volume tracking service 92 which is in communications with the various user devices 10; a data storage area 94 for storing all of the data transferred between the tracking service 92 and the multiple user devices 10; and a reporting analysis engine 96 which analyzes the data accumulated from the devices 10. The analyzed data is accessible for viewing, printing, study and manipulation at the central server via corporate I/O devices 98 such as monitors, printers, scanners, etc.

There are numerous uses of the tracked data accumulated from the multiple user devices. The business intelligence gained from the analysis of the tracked data can be used, for example, to tune applications or services that are consuming more data than desired. In another example, if an associate uses corporate applications on his/her personal data plan, the usage statistics can be processed to determine application or service costs and to allow for employee remuneration. Network bundling data discussions can provide volumetric information on a per-carrier basis, and network option comparisons can be clarified by comparing average response times over various networks. Provider latencies can also be compared and used.

The collected and analyzed tracking data can also be used for validating service level agreement response times, and for troubleshooting device applications to provide knowledge of which applications 22 are consuming data and bandwidth and how much is being consumed by each application 22 over a given period of time. Consumers or personal users can be provided with an alert if they approach or exceed a certain amount of data or bandwidth for a given application or a given network over a specified period of time.

Metrics from data accumulated by the volume tracking service can also be used to determine user percentages, such as the top 10% or the bottom 10% of data volume users, so that users of a particular application 22 can be aware of the expected standard data and use volumes. Any form of data that is tracked can be sent back to the data volume aggregator 90 at the central server including SMS text messaging. For example if an application wrapped an SMS call as a service, the data tracker could be used to track messaging performance across applications and networks.

Applications that use video can also use the volume tracker system and method to track rough video performance. Also a native application which has been developed for use on a particular platform or device can be used with the tracking system and method which could be expanded to extended data tracking, not limited to enterprise BYOD devices, and could be used in either a mobile or non-mobile environment.

The tracking data, e.g. data volume and usage time, from the volume data tracking application 24 on the user device 10 (FIG. 1) is transferred to the data volume aggregator 90 (FIG. 4) located on the central computer where the tracking data is stored in memory 94. The reporting analysis engine 96 analyzes the reported data volume and usage times of the one or more enterprise software applications received from the user device wherein the data volume and usage times of each of the enterprise software applications are differentiated according to at least one parameter selected from the group consisting of user identification, user device type, business unit type, site identifier, service provider, connection type, service endpoint, identifier of a specific process, and identifier of a specific section of an application.

The central computer or the analysis engine 96 can determine employee remuneration costs incurred when the employee uses his personal mobile device (or a company supplied mobile device) loaded with the enterprise software applications in the course of his/her employee duties. The remuneration can be based, for example, on data volume and usage time of the enterprise software applications resident on the user device whereby a predetermined expense rate can be calculated and the monies can be paid for, or reimbursed to, the user. Reimbursement can also cover the costs of a personal data plan, and/or costs of a given service provider or special services necessary or selected to access the enterprise software applications. Moreover, determining remuneration can be based upon secondary factors such as, but not limited to, identification of a service provider, date and time of usage, and identification of the user device.

The central computer or the analysis engine 96 can also determine an optimum cost versus benefit analysis based upon the reported data volume and usage times of the enterprise software applications resident on an user device when comparing predetermined services such as, but not limited to, an internet service, an intranet service, an ES proprietary service, a LAN service, an Ethernet service and a third party service. The central computer or the analysis engine 96 can also determine an optimum cost versus benefit analysis based on the reported data volume and usage times of one or more enterprise software applications when comparing the predetermined connection types including, but not limited to, connections via a telephone cellular interface, a wireless network interface, a wired interface, a tethered interface, a near field communication interface and a bluetooth interface.

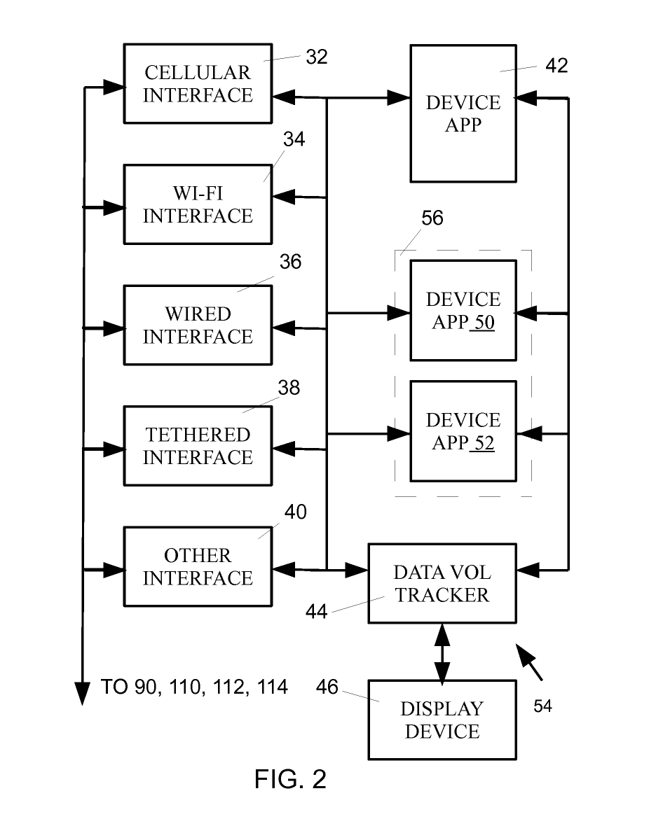

FIG. 2 is a block diagram representation of a second embodiment of a portion of an user's mobile device 54 in communications with an enterprise system including data volume tracking. In this embodiment an application container 56 encloses applications 50, 52 which have been loaded onto the user device 54. The device 54 can include one or more of the following interfaces: a cellular interface 32 for connectivity to a wireless cellular network or service; a wireless local area network (WLAN) or wi-fi interface 34 for connectivity to a wireless local area network or service; a wired interface 36 for connectivity to a network or service; a tethered interface 38 for connectivity with other devices over the Internet; and any other available interface 40 which allows the device 54 to communicate with other devices via any other network or service not identified above.

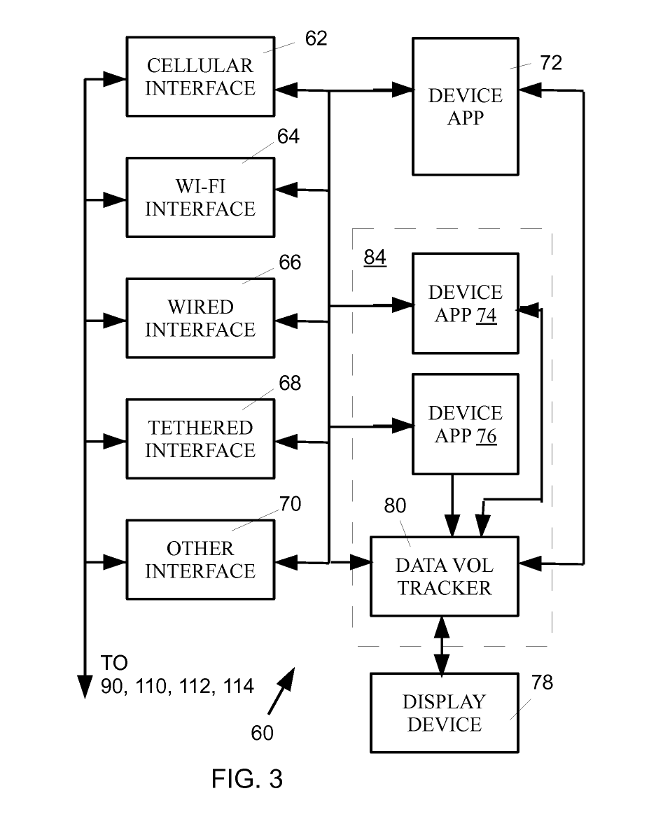

FIG. 3 is a block diagram representation of a third embodiment of a portion of an user's mobile device 60 in communications with an enterprise system including data volume tracking. In this embodiment an application container 84 encloses the data volume tracker 80 plus applications 74, 76 which have been loaded onto the user device 60. The device 54 can include one or more of: a cellular interface 62 for connectivity to a wireless cellular network or service; a wireless local area network (WLAN) or wi-fi interface 64 for connectivity to a wireless local area network or service; a wired interface 66 for connectivity to a network or service; a tethered interface 68 for connectivity with other devices over the Internet; and any other available interface 70 which allows the device 60 to communicate with other devices via any other network or service not identified above.

The computer implemented method for accumulating and analyzing tracking data such as tracking data volume and usage times can also be implemented via a computer program product for use in a mobile user device. The computer program product can include a computer readable storage medium having computer readable program code embodied therewith. The computer readable program code can include: computer readable program code configured to track data volume transfers, usage times and bandwidth used by the user device for external communications via execution of an enterprise application loaded onto the user device; computer readable program code configured to store the data volume transfers, usage times and bandwidth in a memory within the user device and to differentiate data send times, data receive times, service provider data and connection type data; and computer readable program code configured to facilitate transfer of the stored data volume transfers, usage times and bandwidth to an enterprise system server.

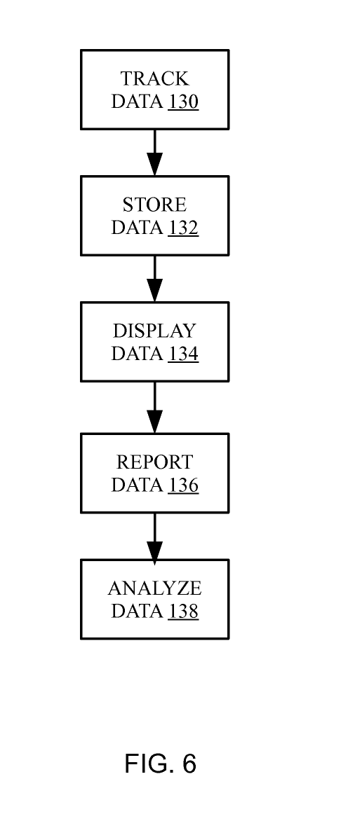

FIG. 6 is a flow chart of steps of a general method according to the principles of the invention whereby data is first tracked by a data tracking program 24 (FIG. 1) which is resident in an user's mobile device in step 130, and the tracked data is stored in a memory 28 in step 132. Then the tracked and stored data is displayed for instance on a display screen 26 of the user's device in step 134. The tracked and stored data is then transferred or reported in step 136 to an analyzer 96 (FIG. 4) located for instance at a remote central computer, and finally the transferred data is analyzed in step 138 such as by the data analysis engine 96 of FIG. 4.

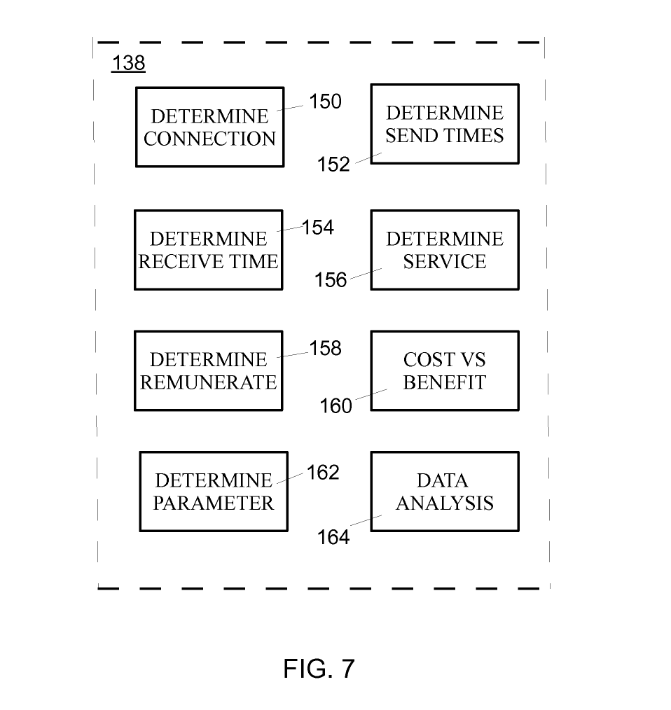

FIG. 7 further delineates the step 138 data analysis of FIG. 7. Step 150 determines when connections have been made by the user's mobile device to predetermined services which, in turn, are determined in step 156. Send times, i.e. the amount or duration of time spent sending data from the user's device is determined in step 152. Receive times, i.e. the amount or duration of time spent receiving data to the user's device is determined in step 154. Step 164 determines and differentiates specific parameters of the enterprise software applications which are differentiated as previously noted by user identification, user device type, business unit type, site identifier, service provider, connection type, service endpoint, identifier of a specific process, and identifier of a specific section of an application. Step 158 determines employee financial remuneration as previously discussed. Cost versus benefit analysis of all the tracking data is established in step 160, and any other desirable analysis of the tracking data is accomplished in step 164.

While the invention has been shown and described with reference to specific embodiments, it should be understood by those skilled in the art that various changes in form and detail may be made therein without departing from the spirit and scope of the invention.

What is claimed is:

1. A computer implemented method for use with an user device in communications with an enterprise system (ES) in a workplace, the method comprising:
tracking data volume and usage times, via a data volume tracker application, of one or more enterprise software applications in the user device;
storing the data volume, duration of usage times and actual date and time of usage in a memory wherein the data volume tracker application differentiates duration of usage time, actual date and time of usage, and volume of data transferred for each service provider, for each connection type and for each of the one or more enterprise software applications; and
periodically reporting the stored data volume, duration of usage times and actual date and time of usage to a central computer of the ES,
wherein said data volume tracker application, said one or more enterprise software applications and said memory are resident on the user device.

2. The computer implemented method of claim 1 wherein said predetermined connection type comprises a connection via: a telephone cellular interface; a wireless network interface; a wired interface; a tethered interface; a near field communication interface; and a bluetooth interface.

3. The computer implemented method of claim 1 wherein said predetermined service provider comprises: an internet service; an intranet service; an ES proprietary service; a LAN service; an Ethernet service; and a third party service provider.

4. The computer implemented method of claim 1 further displaying the stored data volume and usage times for the one or more enterprise software applications on a display of the user device.

5. The computer implemented method of claim 1 further comprising the central computer accumulating and analyzing the reported data volume and usage times of said one or more enterprise software applications received from a plurality of user devices.

6. The computer implemented method of claim 5 wherein the data volume and usage times of said one or more enterprise software applications are differentiated according to at least one parameter selected from the group consisting of user identification, user device type, business unit type, site identifier, service provider, connection type, service endpoint, identifier of a specific process, and identifier of a specific section of an application.

7. The computer implemented method of claim 5 further comprising the central computer determining remuneration, based on data volume and usage time of one or more of the enterprise software applications, at a predetermined expense rate to an user of a given user device for using a personal data plan to access the one or more enterprise software applications.

8. The computer implemented method of claim 7 wherein the step of determining remuneration is further based upon secondary factors including identification of a service provider, date and time of usage, and identification of the user device.

9. The computer implemented method of claim 5 further comprising the central computer determining an optimum cost versus benefit analysis based on the reported data volume and usage times of the one or more enterprise software applications when comparing predetermined services including an internet service, an intranet service, an ES proprietary service, a LAN service, an Ethernet service and a third party service.

10. The computer implemented method of claim 5 further comprising the central computer determining an optimum cost versus benefit analysis based on the reported data volume and usage times of the one or more enterprise software applications when comparing said predetermined connection types including connections via a telephone cellular interface, a wireless network interface, a wired interface, a tethered interface, a near field communication interface and a bluetooth interface.

11. The computer implemented method of claim 1 further comprising an application container resident in the user device to hold and execute commands for running said data volume tracker application and said one or more enterprise software applications.

12. The computer implemented method of claim 1 further comprising an application container resident in the user device to hold and execute commands for running said data volume tracker application.

13. The computer implemented method of claim 1 further comprising an application container resident in the user device to hold and execute commands for running said one or more enterprise software applications.

14. The computer implemented method of claim 1 wherein the user device comprises a cell phone, a smart phone, a personal digital assistant, an enterprise digital assistant, a tablet computer, a laptop computer, a mobile internet device, a desktop computer, a work station computer, a mobile computing device and a portable computing device.

15. A system for tracking data usage comprising:
one or more user devices each comprising an enterprise device application for use within an enterprise system, a connection interface, a memory, an I/O device and a data volume tracker application for measuring tracking parameter data of the enterprise device application; and
a data volume aggregator resident within a server of the enterprise system, said aggregator comprising a volume tracking service for communicating with the one or more user devices, a storage device for storing the parameter data received from the one or more user devices, and an analysis engine for analyzing parameter data received from the one or more user devices,
wherein a service call is initiated by the I/O device of one of the user devices to contact a service via the connection interface to request or send information related to said enterprise device application and wherein the data volume tracker application measures and stores to the memory the parameter data from the user accumulated for a duration of the service call.

16. The system of claim 15 wherein the parameter data comprises: bandwidth used; date and length of communications; differentiation of data received and data sent; device use time for a specific data plan; data volume transfers; overall usage times and bandwidths; data send times;
data received times; service provider data; and connection type data.

17. The system of claim 15 wherein the parameter data stored on the memory of the one or more user devices is transferred via the connection interface to the data volume aggregator.

18. A computer program product for use in a mobile user device, comprising:
a computer readable storage medium having computer readable program code embodied therewith, the computer readable program code comprising:
computer readable program code configured to track data volume transfers, usage times and bandwidth used by the user device for external communications via execution of an enterprise application loaded onto the user device;
computer readable program code configured to store the data volume transfers, usage times and bandwidth in a memory within the user device and to differentiate data send times, data receive times, service provider data and connection type data; and
computer readable program code configured to facilitate transfer of the stored data volume transfers, usage times and bandwidth to an enterprise system server.

19. The computer program product of claim 18 comprising computer readable program code configured to provide an application container to hold and execute commands for running one or more enterprise applications on the user device.
